(19) United States
(12) Patent Application Publication
(10) Pub. No.: US 2013/0333360 A1
(43) Pub. Date: Dec. 19, 2013

(54) SECONDARY AIR INJECTION SYSTEM

(71) Applicant: HYUNDAI MOTOR COMPANY, Seoul (KR)

(72) Inventors: Dong Hee HAN, Seoul (KR); Hyuk Im, Suwon-si (KR); Seung Kook Han, Suwon-si (KR); Cheolho Park, Hwaseong-si (KR); Jaeyoung Jeun, Yongin-si (KR); Jae Hyeok Choi, Seongnam-si (KR); Jong II Park, Seoul (KR)

(73) Assignee: Hyundai Motor Company, Seoul (KR)

(21) Appl. No.: 13/718,198

(22) Filed: Dec. 18, 2012

(30) Foreign Application Priority Data
Jun. 15, 2012 (KR) 10-2012-0064353

(51) Int. Cl. F01N 3/22; F02B 29/04; F02B 37/04

(52) U.S. Cl. CPC F01N 3/222; F02B 37/04; F02B 29/04
USPC 60/289; 60/612; 123/563; 123/564

(57) ABSTRACT

A secondary air injection system supplying some of air introduced into an intake manifold to an exhaust manifold may include: an electric supercharger compressing air introduced through an air duct; throttle valves installed at an upstream of the intake manifold and controlling the amount of air introduced into the intake manifold by controlling the amount of air passing through the electric supercharger; secondary air valves installed on branching paths branched from intake, lines that link the electric supercharger and the throttle vales and controlling the amount of air for secondary air injection; and an injector that post-combusts exhaust gas discharged from an engine by injecting secondary air passing through the secondary air valve to a runner of the manifold.

### CROSS-REFERENCE TO RELATED APPLICATION

The present application claims priority of Korean Patent Application Number 10-2012-0064353 filed on Jun. 15, 2012, the entire contents of which application is incorporated herein for all purposes by this reference.

### BACKGROUND OF INVENTION

1. Field of Invention

The present invention relates to a secondary air injection system. More particularly, the present invention relates to a secondary air injection system that supplies secondary air to exhaust gas by branching air introduced into an intake manifold.

2. Description of Related Art

In a general intake/exhaust system of a vehicle, intake air is supplied to an engine through an intake manifold and the supplied intake air is combusted in the engine to be discharged to the outside through an exhaust manifold.

In this case, exhaust gas includes vapor (H2O), nitrogen (N2), carbon dioxide gas (CO2), and the like which are harmless to human bodies, but also includes toxic materials such as carbon monoxide (CO), hydrocarbon (HC), nitrogen oxide (NOx), and the like.

A secondary air injection method that causes post-combustion by supplying air to the exhaust gas is used in order to remove the toxic ingredients.

FIG. 1 is a schematic diagram of a general secondary air injection system.

Referring to FIG. 1, intake air 44 is compressed by a secondary air pump (SAP) 20 after the intake air 44 is purified through an air filter 42, and as a result, the compressed air is supplied to runners 51, 52, 53, and 54 of an exhaust manifold 50. The air filter 42 serves to remove impurities and moisture included in the air introduced into the engine 10. When the secondary air is supplied, the toxic ingredients are reduced to be converted into the harmless ingredients in a catalyst converter 60. Exhaust gas 62 is discharged to the outside through the aforementioned process. In this case, the amount of the secondary air that is supplied by a secondary air valve 30 is controlled.

That is, air and gas in a combustion chamber are thickly combusted in initial starting and air is mixed with some non-combusted exhaust gas by using the secondary air pump 20 to be post-combusted. That is, the concentration of hydrocarbon which is non-combusted through post-combustion in an exhaust system can be reduced.

However, to this end, since the secondary air pump particularly needs to be provided, a weight and a volume are increased.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a secondary air injection system that assists supercharging of a turbo charger or injects air to exhaust gas by using an electric supercharger applied to a cycle used as a primary supercharging source.

Various aspects of the present invention provide for a secondary air injection system supplying some of air introduced into an intake manifold to an exhaust manifold, including: an electric supercharger compressing air introduced through an air duct; throttle valves installed at an upstream of the intake manifold and controlling the amount of air introduced into the intake manifold by controlling the amount of air passing through the electric supercharger; a secondary air valve installed on branching paths branched from intake lines that link the electric supercharger and the throttle vale and controlling the amount of air for secondary air injection; and an injector that post-combusts exhaust gas discharged from an engine by injecting secondary air passing through the secondary air valve to a runner of the manifold.

The secondary air injection system may further include a turbo charger installed on the intake line, and including a compressor compressing air passing through the electric supercharger and a turbine actuated by exhaust gas passing through the exhaust manifold to drive the compressor.

The secondary air injection system may further include an air cleaner box installed at an upstream of the electric supercharger and purifying introduced air; and a bypass valve branched from the air cleaner box, installed on a bypass line merged with the intake line, and controlling the amount of air introduced into the intake line.

The secondary air injection system may further include an intercooler installed at an upstream of the throttle valve and cooling the air introduced into the intake manifold.

The branching path may be branched at an upstream or a downstream of the compressor, the electronic supercharge is constituted by a motor and a compressor, and the compressor is driven by the motor.

According to various aspects of the present invention, harmless ingredients of discharge gas is reduced even without a secondary air injection pump and the amount of precious metals of a catalyst can be reduced by activating the catalyst in initial starting, and low-speed and high-speed performance can be improved due to a reduction of back pressure as a catalyst system is reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a general secondary air injection system.

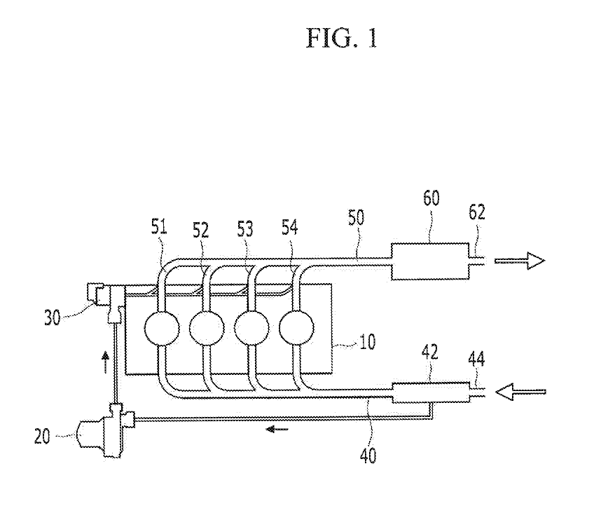

FIG. 2 is a diagram illustrating an exemplary secondary air injection system assisting supercharging of a turbo charger according to the present invention.

FIG. 3 is a diagram illustrating an exemplary secondary air injection system applied to a Miller cycle according to the present invention.

FIG. 4 is a graph illustrating an exemplary change in pressure at an upstream of a throttle valve and an exemplary change in rotating speed in the turbo charger according to various aspects of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Like reference numerals designate like components throughout the specification.

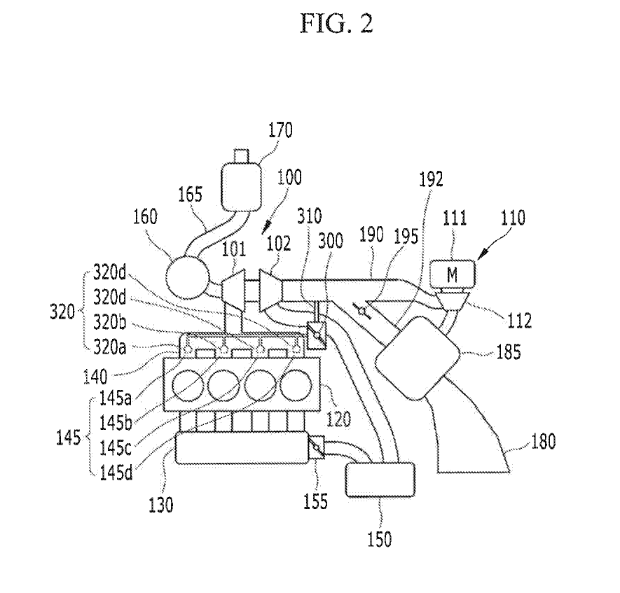

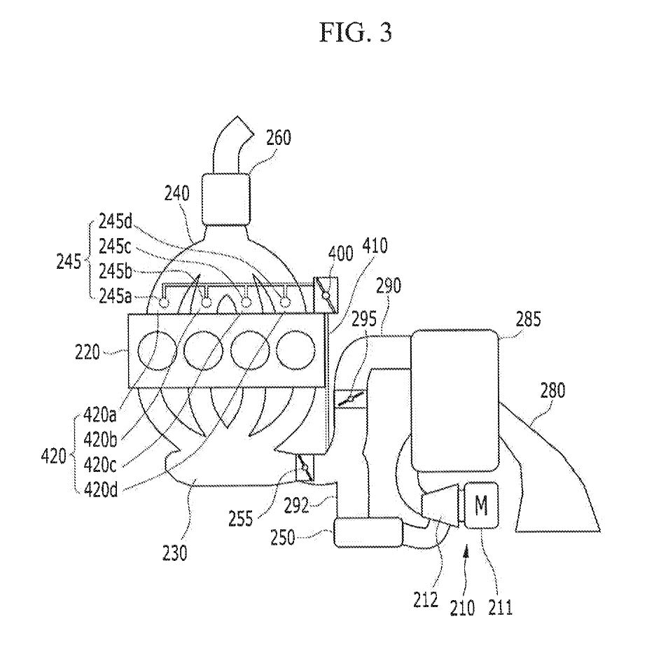

FIGS. 2 and 3 are diagrams illustrating a secondary air injection system according to various embodiments of the present invention.

Various embodiments of the present invention provides a secondary air injection system including electric superchargers 110 and 210 compressing air introduced through air ducts 180 and 280, throttle valves 155 and 255 installed at an upstream of intake manifolds 130 and 230 and controlling the amount of air introduced into the intake manifolds 130 and 230 by controlling the amount of air passing through the electric superchargers chargers 110 and 210, secondary air valves 300 and 400 installed on branching paths 310 and 410 branched from intake lines 190 and 292 that link the electric superchargers 110 and 210 and the throttle vales 155 and 255 and controlling the amount of air for secondary air injection, and a plurality of injectors 320a, 320b, 320c, 320d, 245a, 245b, 245c, and 245d post-combusting exhaust gas discharged from engines 120 and 220 by injecting secondary air passing through the secondary air valves 300 and 400 to runners 145a, 145b, 145c, 145d, 420a, 420b, 420c, and 420d of the exhaust manifolds 140 and 240 and supplying some of air introduced into the intake manifolds 130 and 230 to the exhaust manifolds 140 and 240. The electric superchargers 110 and 210 are constituted by motors 111 and 211 and compressors 112 and 212, and the compressors 112 and 212 are driven by the motors 111 and 211 to compress the introduced air.

In various embodiments according to the present invention, the secondary air injection system includes air cleaner boxes 185 and 285 installed at an upstream f the electric superchargers 110 and 210 and purifying the introduced air and bypass valves 195 and 295 branched from the air cleaner boxes 185 and 285, installed on bypass lines 192 and 290 merged with the intake lines 190 and 292, and controlling the amount of air introduced into the intake lines 190 and 292, and includes intercoolers 150 and 250 installed at an upstream of the throttle valves 155 and 255 and cooling air introduced into the intake manifolds 130 and 230.

Various embodiments of the present invention provide for a secondary air injection system applied to a supercharging assisting system of a turbo charger and a secondary air injection system applied a Miller cycle used as a primary supercharging source.

Hereinafter, a configuration of various embodiments of the present invention will be described in more detail.

In accordance with various embodiments of the present invention, the system includes a turbo charger including a compressor 102 and a turbine 101 compressing air passing through the electric supercharger 110, and the turbine 101 is connected with the exhaust manifold 140 and driven by exhaust gas passing through the exhaust manifold 140 to drive the compressor 102.

In the above embodiments, air for secondary air injection may be branched at an upstream or a downstream of the compressor 102, and when the air is branched at the upstream of the compressor 102, low-pressure air may be supplied to the exhaust system and when the air is branched at the downstream, higher-pressure air may be supplied to the exhaust system. Therefore, a position branched according to air pressure supplied to the exhaust system may be selected.

In various embodiments according to the present invention, a warming-up catalytic converter (WCC) 160 and a under-floor catalytic converter (UCC) 170 catalyst may be mounted, and the WCC 160 catalyst is installed to be close to the engine 120 and a three way catalyst in which a purification rate for THC, NOx, and CO is excellent. The UCC 170 is mounted at a predetermined position of an exhaust line 165 connected with the WCC 160.

Hereinafter, referring to FIG. 2, an operation of various embodiments will be described in more detail.

FIG. 2 illustrates a use example in which the secondary air injection system is applied to a turbo charger 100 assisting system according to various embodiments of the present invention, and referring to FIG. 2, air is first introduced through an air duct 180 and the introduced air is purified in the air cleaner box 185 and branched, and thereafter, some is introduced into the bypass line 192 and the rest thereof is introduced into the electric supercharger 110.

A bypass valve 195 is installed on the bypass line 192 to control the amount of air circulated through the bypass line 192. The air introduced into the electric supercharger 110 is compressed by the compressor 112 that is actuated by the motor 11 and as a result, some is introduced into the compressor 102 through the intake line 190 and the rest is introduced into the branching path 310. The compressor 102 is connected with the turbine 101 on the same shaft to be driven by using exhaust energy in the turbine 101.

Further, secondary air introduced through the branching path 310 is supplied to exhaust gas discharged from the respective runners 145a, 145b, 145c, and 145d of the exhaust manifold 140 with a flow rate of the secondary air controlled by the secondary air valve 300. The exhaust gas is post-combusted by the supplied secondary air to remove the toxic ingredients of the exhaust gas.

The air introduced through the compressor 102 is cooled by passing through the intercooler 150 to be introduced into the intake manifold 130 and the throttle valve 155 is installed at an upstream of the intake manifold 130 to control the amount of introduced air.

The air introduced into the intake manifold 130 is combusted in the engine 120 and discharged to the exhaust manifold 140, and while the exhaust gas is introduced into the turbine 101, the turbine 101 and the compressor 102 connected with the turbine 101 are driven.

The WCC 160 is installed at a downstream of the turbine 101 and the UCC 170 is installed on the exhaust line 165 to remove the toxic ingredients of the exhaust gas.

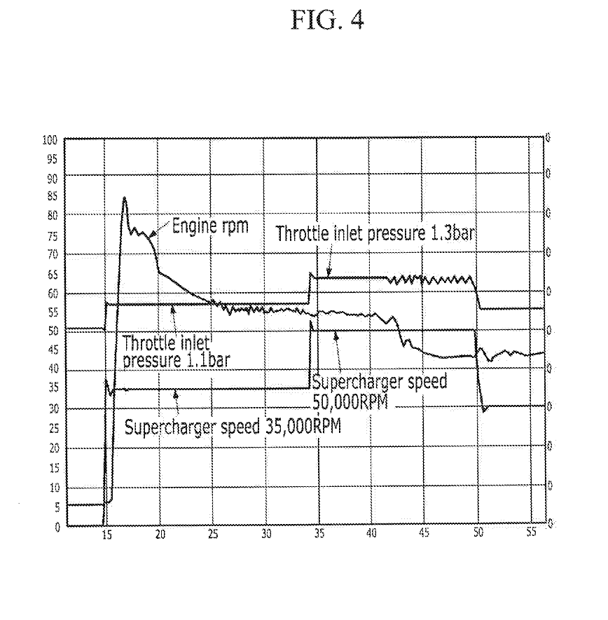

FIG. 4 is a graph illustrating a change in rotating speed in the supercharger 110 depending on a change in pressure at an upstream of the throttle valve 155 according to various embodiments of the present invention. It can be seen that the change in pressure at the upstream of the throttle valve 155 and the change in rotating speed of the motor 111 of the supercharger 110 occur substantially at the same time. That is, the rotating speed of the motor 111 is increased from 35,000 rpm to 50,000 rpm while the pressure at the upstream of the throttle valve 155 is increased from 1.1 bar to 1.3 bar to precisely control a secondary air injection amount.

Furthermore, since a secondary air injection amount introduced into an injector 320 may be controlled even by the bypass valve 195 and the secondary air valve 300, the pressure at the upstream of the throttle valve 155 and the secondary air injection amount may be precisely controlled. That is, in order to prevent an intake amount introduced into the intake manifold 130 from being short, by checking the pressure at the upstream of the throttle valve 155, when the pressure is low, an air supply amount to the intake manifold 130 is prevented from being short by increasing the pressure at the upstream of the throttle valve 155 and increasing the rotating speed of the motor 111. In this case, an opening rate is increased by further opening the bypass valve 195 to increase the amount of air that is introduced and the intake amount may be increased by closing the secondary air valve 30.

The discharge gas and catalyst heating may be optimized by precisely controlling the second air injection amount as described above, and prime cost caused by a reduction in contents of the catalyst and the precious metals may be saved by reducing the discharge gas at the time of applying the electric supercharger 110 by integrating the electric supercharger 110 and the secondary air valve 300.

Hereinafter, other embodiments according to the present invention will be described with reference to FIG. 3.

FIG. 3 is a schematic diagram illustrating a secondary air injection system applied to a Miller cycle according to various embodiments of the present invention. Referring to FIG. 3, since the secondary air injection system according to other embodiments is substantially similar to the secondary air injection system according to the above embodiments except that the turbo charger is omitted, the same components as those of the above embodiments will not be described and hereinafter, an operating process of other embodiments will be described.

First, external air is first introduced into the air cleaner box 285 through the air duct 280 to be purified and thereafter, the purified air is respectively branched and introduced into the bypass line 290 and the electric superchargers 110 and 210. The bypass valve 295 is installed on the bypass line 290 to control the amount of air passing through the bypass line 290 and the air passing through the electric supercharger 210 is compressed by the compressor 212 driven by the motor 211. The compressed air is cooled while passing through the intercooler 250 and the cooled air is introduced into the intake manifold 230 through the intake line 292, and the throttle valve 255 is installed at an upstream of the intake manifold 230 to control the amount of air introduced into the intake manifold 230.

In various embodiments a secondary air valve 400 is installed on a branching path 410 branched from the intake line 292. The injectors 245a, 245b, 245c, and 245d that inject secondary air are installed at the respective runners 420a, 420b, 420c, and 420d of the exhaust manifold 240.

In this case, the air introduced into the intake manifold 230 is combusted in the engine 220 to be discharged to the outside through the exhaust manifold 240 and a catalyst device 260 purifying toxic materials included in the exhaust gas is attached to the exhaust manifold 240 to remove the toxic ingredients of the exhaust gas.

In various embodiments, the secondary air injection amount may be precisely controlled by the throttle valve 255, the bypass valve 295, and the motor 211 of the supercharger 210 similarly as the above embodiments.

Therefore, the discharge gas and the catalyst heating may be optimized and the contents of the catalyst and the precious metals may be reduced by reducing the discharge gas to save prime cost.

The secondary air injection system according to various embodiments of the present invention is used as the secondary air injection pump during an initial catalyst heating period after starting, and since the number of components may be decreased, production cost may be reduced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A secondary air injection system partially supplying air introduced into an intake manifold to an exhaust manifold, comprising:
an electric supercharger compressing air introduced through an air duct;
a throttle valve installed upstream of the intake manifold and controlling the amount of air introduced into the intake manifold by controlling the amount of air passing through the electric supercharger;
a secondary air valve installed on branching paths branched from intake lines that link the electric supercharger and the throttle vale and controlling the amount of air for secondary air injection; and
an injector that post-combusts exhaust gas discharged from an engine by injecting secondary air passing through the secondary air valve to a runner of the manifold.

2. The secondary air injection system of claim 1, further comprising:
a turbo charger installed on the intake line, and including a compressor compressing air passing through the electric supercharger and a turbine actuated by exhaust gas passing through the exhaust manifold to drive the compressor.

3. The secondary air injection system of claim 2, further comprising:
an air cleaner box installed upstream of the electric supercharger and purifying introduced air; and
a bypass valve branched from the air cleaner box, installed on a bypass line merged with the intake line, and controlling the amount of air introduced into the intake line.

4. The secondary air injection system of claim 3, further comprising:
an intercooler installed upstream of the throttle valve and cooling the air introduced into the intake manifold.

5. The secondary air injection system of claim 2, wherein:
the branching path is branched upstream or downstream of the compressor of the turbo charger.

6. The secondary air injection system of claim 1, wherein:
the electric supercharger is constituted by a motor and a compressor, and the compressor is driven by the motor.

7. The secondary air injection system of claim 1, further comprising:
an air cleaner box installed upstream of the electric supercharger and purifying introduced air; and
a bypass valve branched from the air cleaner box, installed on a bypass line merged with the intake line, and controlling the amount of air introduced into the intake line.

8. The secondary air injection system of claim 7, further comprising:
an intercooler installed upstream of the throttle valve and cooling the air introduced into the intake manifold.
